(19) United States
(12) Patent Application Publication
(10) Pub. No.: US 2010/0138911 A1
(43) Pub. Date: Jun. 3, 2010

(54) INTERNET-BASED AUTOMATIC SECURITY SYSTEM AND METHOD

(75) Inventors: Chun-Cheng LIN, Hsinchu City (TW); Chia-Feng Kang, Taichung City (TW)

Correspondence Address: EGBERT LAW OFFICES, 412 MAIN STREET, 7TH FLOOR, HOUSTON, TX, 77002, US

(73) Assignee: National Chin-Yi University of Technology, Taiping City (TW)

(21) Appl. No.: 12/327,703

(22) Filed: Dec. 3, 2008

(51) Int. Cl. H04L 9/32

(52) U.S. Cl. 726/15

(57) ABSTRACT

The preset invention provides an Intrnet-based automatic security system and method. The security system includes a network server with a database, a network detection module and an automatic transmitting module, and a security device with a microcontroller, a virtual IP network module and wireless transmission module. The network detection module receives the information of security device and detects the networking state. The automatic transmitting module automatically transmits the alarm information from the network detection module to the client and security operator. The microcontroller links security components. The virtual IP network module employs a virtual IP address and links to a virtual IP router through a transmission interface. The security device also contains a polling module automatically linked to the network server for reading data.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a security system and method, and more particularly to the innovative system and method which enables security information transmission by means of Internet.

2. Description of Related Art Including Information Disclosed Under 37 CFR 1.97 and 37 CFR 1.98.

In a modern society, most companies, factories and business operators are equipped with a security system for safeguarding their security and guarding against theft.

A typical security system is designed in such a manner to be mounted between field security devices, or between security devices and host computers of security operators via telephone lines. But, the layout of telephone lines will become more complicated with the increase of security devices in the field, bringing about more inconvenience and higher installation costs. Moreover, the complex wiring will have a great impact on future operations, such as malfunction or even shutdown arising from ageing of lines and natural/man-made damages. Therefore, it is necessary to make a breakthrough in the design of a security system with regard to the progress of research and development and to growth in customer demands.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

The security devices of the present invention integrate the security components, microcontroller, virtual IP network module and wireless transmission module, so the security devices are easy to install. Hence, the user may purchase the security devices with security components of special functions, where necessary.

Virtual IPs are distributed automatically to the security devices 20 by the virtual IP router that employs mobile or fixed IP address, so the network expense of the user is not increased. Moreover, this allows flexibly increasing or reducing of the quantity of security devices without affecting the setting and configuration of original security devices.

In addition to HTML web page, the server of the present invention can also provide a WML or XHTML web page, enabling the users of mobile phones to inquire about or set the security devices of security field through WML or XHTML web page.

The combination of network servers and telephones allows to telephone automatically the users and police stations, thereby saving greatly the labor cost.

The security devices of the present invention employs a polling method, so bidirectional transmission between the security device and server can be realized even though the security device is provided with virtual IP address without the function of servo host computer.

The server of the present invention can, depending on whether the security device is linked to it on time, inquire about the data and detect automatically if the network is disconnected.

If an imaging element is equipped, the present invention can be used as a remote monitoring system. The image data are transmitted to the server only when alarm signals exist in the security field, or the user requires examining the imaging device. No image data are required to be stored if only the user requires examining the imaging device. But, image data shall be stored in the database of the server in the presence of alarm signals. Thus, it is not required to continuously store the numerous image data, saving substantially storage expenses.

The security operator can monitor several security fields by just mounting a single server, or all users can be linked to the server for inquiring about or setting the security devices of the security field.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a schematic view of a simplified preferred embodiment of the security system of the present invention.

FIG. 2 is a schematic view of a block diagram of the preferred embodiment of the security system of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

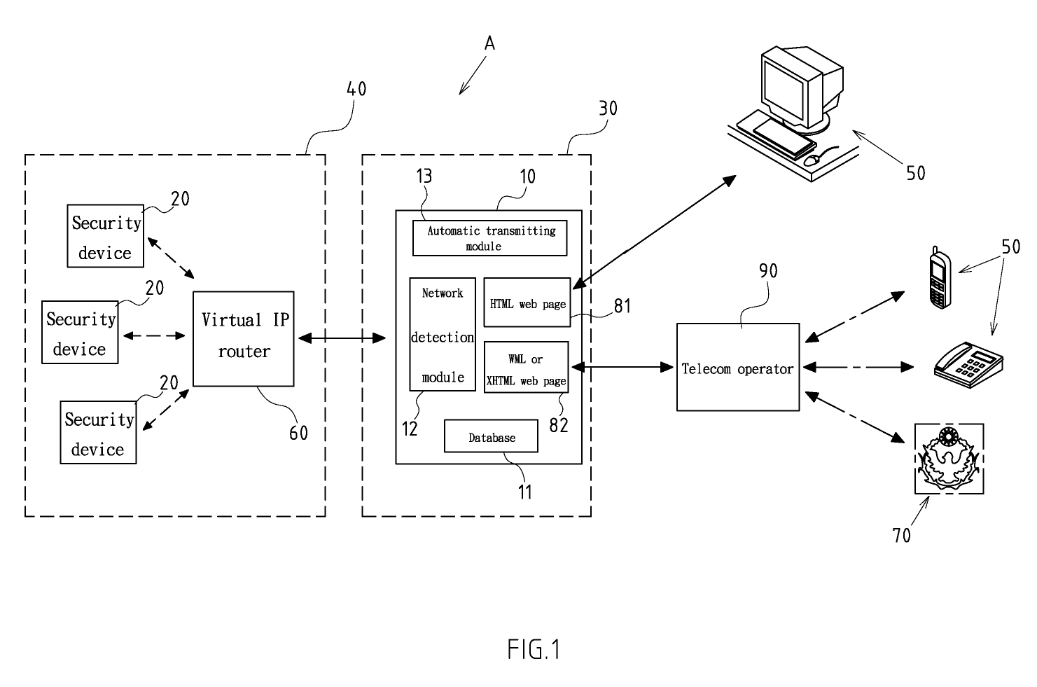

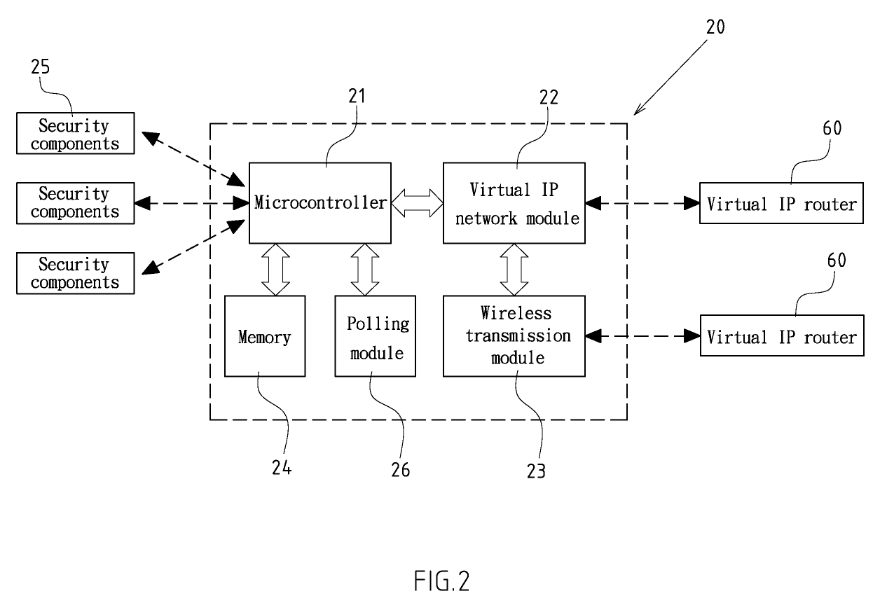

FIGS. 1-2 depict preferred embodiments of the Internet-based automatic security system and method of the present invention. The embodiments are only provided for explanatory purposes with respect to the patent claims.

The Intrnet-based automatic security system A comprises a network server 10 and at least a security device 20. The network server 10 is mounted at the security operator 30, and the security device 20 is mounted at the security field 40. The network server 10 includes a database 11, a network detection module 12 and an automatic transmitting module 13. The database 11 is used to store information. The network detection module 12 used to receive the information of security device 20 and to detect if the networking state is disconnected. The automatic transmitting module 13 is used to transmit automatically the abnormal information from the network detection module 12 to the client 50 and security operator 30.

Referring to FIG. 2, the security device 20 comprises a microcontroller 21, a virtual IP network module 22, a wireless transmission module 23 and a memory 24. The microcontroller 21 is used to link the preset security components 25, including: electronic door locks, imaging devices, spring switch, human body infrared sensors, smoke detectors, gas detectors and buzzers. With a virtual IP address, the virtual IP network module 22 is linked to a virtual IP router 60 through a wireless or wired network transmission interface, such that the information of the security field 40 are transmitted via Internet to the network server 10. Virtual IPs are distributed automatically to the security devices 20 by the virtual IP router 60. When the area of security field is bigger, wireless network transmission will reduce greatly the installation cost. The virtual IP network module 22 employs a TCP/IP (Transmission Control Protocol/Internet Protocol) virtual IP network module.

The security operator 30 can monitor several security fields 40 once a single network server 10 is mounted. Alternatively, all clients 50 can be linked to the network server 10 for inquiring or setting the state of security devices 20 at the security field 40. The network server 10 can also send automatically alarm information to the client 50 and police station 70 through email, real-time communicator and Internet telephone.

Moreover, a single security field 40 is also equipped with several security devices 20, which are linked to virtual IP router 60 via a wireless or wired network.

The present invention is mainly characterized in that the microcontroller 21, virtual IP network module 22 and wireless transmission module 23 are integrated onto a single security device 20, so the security components 25 can be linked to the microcontroller 21 without need of remote wiring or wireless transmission interface. The security device 20 may employ the power supply from the battery or the nearby security field 40 and can be linked to virtual IP router 60 through a wireless network. Thus, the users may purchase, where necessary, the security device 20 that is easy to install and offers security components of specific functions.

For the Internet-based automatic security system of the present invention, the “automation” means the network server 10 can transmit automatically alarm information to the client 50 and police station 70 without relying on the operators on duty. The network server 10 can detect automatically if the networking is disconnected. If so, it can transmit automatically alarm information to the client 50 and security operator 30. Also, the network server 10 can manage and monitor simultaneously several security field 40 or permits several clients to be linked to it via computer or mobile phone for inquiring or setting the state of security devices 20 at the security field 40.

At the security field 40, a few groups of security devices 20 may be installed, each of which is connected with the security components 25 through the microcontroller 21. Every group of security device 20 is available with a virtual IP network module 22. With the use of virtual IP (Intrnet Protocol) address, the virtual IP network module 22 is linked to virtual IP router 60 via wired or wireless interface, then the information of security field 40 is transmitted to the network server 10 of the security operator 30 via Internet.

The network server 10 can store all information of security field 40 in the database 11. When receiving alarm information from the security field 40, it can transmit automatically alarm information to the client 50 and police station 70. The network server 10 can provide HTML web page 81 in the form of HTML (Hyper Text Markup Language), enabling the user to log onto HTML web page 81 via Internet, and set and inquire about the security devices 20 specific to the security field 40. Also, the network server 10 can provide WML or XHTML web page 82 in the form of WML (Wireless Markup Language) or XHTML (Extended Hyper Text Markup Language), enabling the client 50 to link its mobile phone to Internet through telecom operator 90, and then to the network server 10, so as to set and inquire about the security devices 20 specific to the security field 40.

The present invention is mainly characterized in that, the security devices 20 distribute automatically virtual IP addresses through virtual IP router 60, allowing to increase or reduce flexibly the quantity of security devices without need of modifying the configuration of original security devices. Only a mobile or fixed IP is required by the client, so the network expense of the client is not increased. Since the security devices of the security field adopt virtual IP address without the function of servo host computer, the network server 10 cannot be actively linked to a security device 20 though the latter one can be linked actively via Internet to the former one. To realize bidirectional transmission between the security device 20 and the network server 10, the database 11 of the network server 10 of the present invention is designed in such a manner to store the inquiry or setting requirements of the users on the web page.

The network server 10 for the security operator permits the security device 20 to upload the information (images or state of magnetic reed switch) of security components 25 after networking, or download the preset commands of security components 25 (e.g. the command of a user for unlocking an electronic door). As the network server 10 is fitted with HTML web page, the user is allowed to log onto the network server 10 via computer or PDA, and then inquire about or set the security devices 20 of the security field 40.

When an intrusion is detected by the security components 25, the security device 20 will transmit alarm information to the network server 10. If the security field 40 is equipped with an imaging device, the image data will be uploaded to the network server 10. After receiving the alarm information sent by the security device 20, the network server 10 can automatically send it to the client 50 via emails, or through Microsoft's MSN or Yahoo's real-time communicator. The network server 10 can also automatically telephone the user with mobile phone or fixed phone, or the police station in the jurisdiction based on the functions of network telephone (e.g. Skype telephone launched by PC home).

Since the security devices 20 of the security field adopt virtual IP address without the function of servo host computer, the network server 10 cannot be actively linked to a security device 20 though the latter one can be linked actively via Internet to the former one. To realize bidirectional transmission between the security device 20 and the network server 10, the database 11 of the network server 10 of the present invention is designed in such a manner to store not only the information uploaded by the security devices 20, but also the inquiry or setting requirements of the users on the web page. The security device 20 is equipped with polling module 26 (shown in FIG. 2), which reads the data of the database 11 at an interval (approx. 0.5s or 1s, depending on the response speed of the system) and judges if the user requires to inquire about or set the security device 20. If not, the polling continues. If yes, the data of the security device 20 are uploaded, or the set commands are downloaded. The other characteristic of the polling method is that, when the security device is found not linked to the network server 10 within a predefined time, the networking disconnection is judged. In such case, the network server 10 transmits automatically alarm information to the user or the security operator for finding out the reason of networking disconnection.

1. An Internet-based automatic security system, comprising:
a network server being comprised of a database, a network detection module and an automatic transmitting module, said database storing information, said network detection module receiving information regarding status and detecting a networking state, said automatic transmitting module automatically transmitting alarm information from said network detection module; and
a security device, being comprised of a microcontroller, a virtual IP network module and a wireless transmission module, said microcontroller linking preset security components, said virtual IP network module employing a virtual IP address and linking to a virtual IP router through a transmission interface, information of security field being transmitted via Internet to said network server, said security device being further comprised of a polling module, linked automatically at an interval to said network server for reading data and judging inquiry about or setting the security device.

2. The system defined in claim 1, wherein the security component is selected from a group consisting of: electronic door lock, imaging device, spring switch, human body infrared sensor, smoke detector, gas detector and buzzer.

3. The system defined in claim 1, wherein said security device is further comprised of a memory.

4. An Intrnet-based automatic security method, the method comprising the steps of:
equipping a security operator with a network server to store data and detect automatically a networking state, automatically transmitting alarm information;
providing a security field with at least a virtual IP network module, linking a security device of a wireless transmission module to preset security components, employing a virtual IP address by the virtual IP network module and linking to a virtual IP router through a transmission interface, information of the security field being transmitted via Internet to a network server; and
automatically linking the security device at intervals to the network server by polling, reading data and judging client inquiries about or setting said security device.

5. The method defined in claim 4, wherein said security components is selected as at least one of consisting of: electronic door lock, imaging device, spring switch, human body infrared sensor, smoke detector, gas detector, buzzer and combinations thereof.

6. The method defined in claim 4, further comprising the step of:
automatically sending alarm information to the client, security operator and police station through email, real-time communicator and Internet telephone.

7. The method defined in claim 4, wherein said server is provided with an HTML web page, enabling log onto the network server via computer or PDA, inquiring about or setting the security devices of the security field.

8. The method defined in claim 4, wherein said server is provided with WML or XHTML web page, enabling linkage to a mobile phone to Internet through telecom operator, and then to the network server, so as to inquire about or set the security devices specific to the security field.
